(19) United States
(12) Patent Application Publication
(10) Pub. No.: US 2004/0130296 A1
(43) Pub. Date: Jul. 8, 2004

(54) Method and assembly for determining the output capacity of a battery

(76) Inventors: Christof Gross, Weinstadt-Struempfelbach (DE); Rainer Maeckel, Koenigswinter (DE); Reinhard Seyer, Rodgau (DE); Roger Zimmerman, Ebersbach (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/468,858

(22) PCT Filed: Jan. 18, 2002
(86) PCT No.: PCT/EP02/00469

(30) Foreign Application Priority Data
Feb. 24, 2001 (DE) 101 09 049.8

(51) Int. Cl. H02J 7/00

(52) U.S. Cl. 320/133

(57) ABSTRACT

A method for determining the performance of a battery for providing a vehicle power supply system voltage for a vehicle power supply system in particular in a vehicle, is provided in order to identify the serviceability of a battery in as simple and reliable a manner as possible, in which method the vehicle power supply system voltage (U) is recorded, in which process the vehicle power supply system voltage (U) and the vehicle power supply system current (I) are monitored for an operating mode which can be predetermined within a time window (Z) which can be predetermined, such that the vehicle power supply system voltage (U) at the end of the time window (Z) exceeds a limit value (G) which can be predetermined, as a function of the vehicle power supply system current (I) which is emitted during that operating mode.

The invention relates to a method for determining the performance of a battery for providing a vehicle power supply system voltage for a vehicle power supply system, in particular in a vehicle. The invention also relates to an arrangement for determining the performance.

Safety-relevant functions in vehicles are increasingly being operated electrically, for example electrical brakes. In order to ensure that the serviceability of such safety-relevant components is guaranteed, they must be supplied with electrical power all the time. To do this, it is known for two power sources to be provided in the vehicle, specifically a battery and a generator.

Since the life of a conventional lead-acid battery is generally shorter than the life of a vehicle, it is possible for only one of the two power sources to be serviceable. DE 195 17 709 discloses a method for monitoring the serviceability state of a battery by means of its battery voltage, with the result of the monitoring process being used to decide whether a machine which is connected to the battery is or is not allowed to continue operating.

In the situation where a battery is discharged or defective, and is thus unserviceable, it is also possible for the second power source, the generator, to be damaged or overloaded. This can lead to the supply to the load no longer being guaranteed. Furthermore, the vehicle may enter a safety-critical state. For this reason, measures are required which on the one hand warn the driver while also on the other hand maintaining the vehicle power supply system and hence the vehicle in an operationally safe state for as long as possible. For this purpose, for example, only safety-relevant loads can be switched on or connected. For operational or safety reasons, it is thus necessary to ensure that a minimal amount of current demand for the small number of safety-relevant loads is covered even in the event of a generator failure. Furthermore, a minimum voltage level must be ensured in additon to the current.

The state of charge and the ageing state of the battery are frequently determined in order to establish the preconditions for emergency operation. Methods such as these are normally dependent on what are referred to as resting voltage measurements. In this case, the vehicle has to be rested for relatively long times in order to measure the rest voltage. This cannot be done, particularly in a moving vehicle. Furthermore, it is impossible to determine the instantaneous battery state during external battery charging or when a battery is replaced, for example by a battery with a different rated capacity.

The invention is thus based on the object of specifying a method for determining the performance of a battery, which allows the serviceability of the battery to be identified as easily and reliably as possible. A further aim is to specify a particularly simple and low-cost arrangement for determining the performance of the battery.

The first-mentioned object is achieved according to the invention by a method for determining the performance of a battery which provides a vehicle power supply system voltage for a vehicle power supply system, in which the vehicle power supply system voltage is recorded, with the vehicle power supply system voltage and the vehicle power supply system current being monitored within a time window which can be predetermined for an operating mode which can be predetermined to determine whether the vehicle power supply system voltage exceeds a limit value, which can be predetermined, at the end of the time window, as a function of the vehicle power supply system current which is emitted during that operating mode. The invention is in this case based on the idea that a check should be carried out to determine whether the battery can emit a predetermined current at a specific voltage level, in order to assess the performance and hence the serviceability of the battery. This is done by monitoring a load situation which is characterized by a voltage/current characteristic, for example an operating mode which can be predetermined in a vehicle, for compliance with the relevant voltage/current characteristic, in particular within a time window which can be predetermined.

A check is expediently carried out within the time window to determine whether the vehicle power supply system voltage falls and rises again in response to a vehicle power supply system current which is characteristic of the relevant operating mode. In one particularly preferred embodiment, a check is carried out during the operating mode to determine whether the vehicle power supply system voltage increases within a time window which lasts for a few seconds, in particular for 3 or 15 seconds. A process of starting a vehicle is preferably predetermined as the operating mode. In this case, the current and voltage in the vehicle power supply system are recorded and monitored, for example, during a starting process. A particularly high current flows especially during the process of starting a vehicle. The current drawn during the starting process is in this case greater than the current drawn during an emergency operation phase. The “starting process” operating mode is thus particularly suitable for accessing the performance, in particular for assessing the capability of the battery to be used for emergency operation.

This is based on the assumption that the minimum requirements for emergency operation are satisfied when the battery is found to have adequate performance on the basis of the recorded and assessed voltage/current characteristic for the starting process. This is done in particular by monitoring the profile of the vehicle power supply system voltage during the starting process. If the vehicle power supply system voltage at the end of the starting process rises again and thus reaches a threshold value which characterizes the lower voltage level, then the conditions for emergency operation of the battery are satisfied. If, in contrast, the vehicle power supply system voltage falls below a threshold value, then the conditions for emergency operation are not satisfied, and this is indicated, for example by outputting a signal to the driver.

Furthermore, the vehicle power supply system current is recorded and monitored at the same time. This ensures that the load which is required for assessment of the performance of the battery is being applied. This is achieved in particular in the “starting process” operating mode. A charging current flowing into the battery and/or a vehicle power supply system current flowing out of the battery are/is advantageously recorded during an operating mode which can be predetermined, and is used as the basis to determine a charge balance. In this case, “normal operation” (=the vehicle is being driven) is predetermined as the operating mode. During normal operation, the current flowing into the battery and the current flowing out of the battery are preferably determined and balanced.

This is done by comparing the two values with one another. If the charge balance resulting from the comparison is positive, that is to say the charging current is greater than the vehicle power supply system current, then emergency operation is adequately ensured. If, on the other hand, the charge balance is negative, and in particular is negative over a lengthy time period, then emergency operation is not sufficiently ensured. An appropriate warning is passed to the driver of the vehicle by means of a signal which is emitted. Alternatively or additionally, a charge balance which is negative at times but which does not endanger emergency operation can be emitted. This is advantageously done by monitoring the charge balance for a negative value for a first time limit value which can be predetermined.

In additon, the available charge in the battery is expediently determined. Furthermore, the vehicle power supply system load is advantageously recorded. This makes it possible to vary the time limit value by monitoring the available charge of the battery. In this case, the time limit value indicates that time period in which a permanently negative charge balance is permissible. If this time period is exceeded, power emission from the battery as required for emergency operation will be available only to a limited extent, or will not be guaranteed. In this case, a measure for the load capacity of the battery is preferably determined on the basis of the recorded vehicle power supply system voltage and the available remaining charge.

The ambient temperature, for example the operating temperature of the battery, and/or the engine temperature are expediently recorded. Since, in one preferred embodiment, the method can be implemented using instantaneous operating temperatures, appropriate operating characteristic variables, such as the operating temperature and/or engine temperature, are recorded in order to take account of ageing factors which influence the battery.

The second-mentioned object is achieved according to the invention by an arrangement for determining the performance of the battery, in which a monitoring unit is provided, which is arranged between the battery and the vehicle power supply system, and has at least one sensor for recording the vehicle power supply system voltage and one sensor for recording the vehicle power supply system current, with the monitoring unit having a means for monitoring the vehicle power supply system voltage and the vehicle power supply system current within a time window which can be predetermined for an operating mode which can be predetermined. A timer is preferably provided in order to record the time window.

The sensor for recording the vehicle power supply system current is expediently designed such that the vehicle power supply system current which flows out of the battery and/or a charging current which flows into the battery can be determined. Furthermore, a means for determining the charge balance of the battery is preferably provided for monitoring and assessment of the performance as influenced by the instantaneous operating load on the battery. Furthermore, a sensor for determining an ambient temperature or an engine temperature is provided in order to record further characteristic variables which influence the battery.

In one preferred embodiment, the monitoring unit has a computer unit, in particular a microcontroller, for automatic recording and monitoring of the vehicle power supply system variables, for example the vehicle power supply system voltage, the vehicle power supply system current or the battery voltage, the battery current. For central monitoring, the monitoring unit is connected to a data bus, in particular a CAN bus in a vehicle, with a change in the vehicle power supply system load being identified by means of data which is transmitted via the data bus.

The advantages which are achieved by the invention are, in particular, that the invention makes it possible to make a statement about the present performance of the battery by recording, monitoring and assessing the voltage/current characteristic of the battery during a predetermined operating mode, in particular within a predetermined time window, independently of the environmental conditions of the battery and independently of the battery type and its rated capacity. In particular, the method and the arrangement are independent of rest times or other boundary conditions which are normally required for assessment of the state of charge of a battery.

Exemplary embodiments of the invention will be explained in more detail with reference to the drawing, in which:

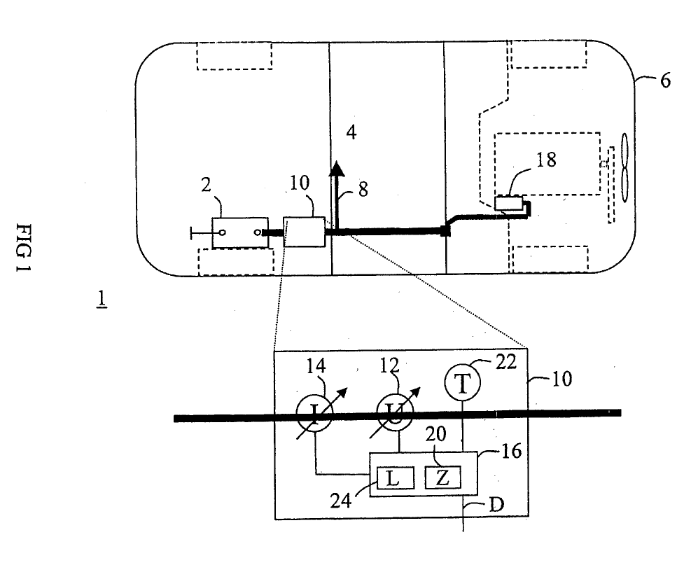

FIG. 1 shows, schematically, an arrangement with a monitoring unit for determining the performance of a battery, and

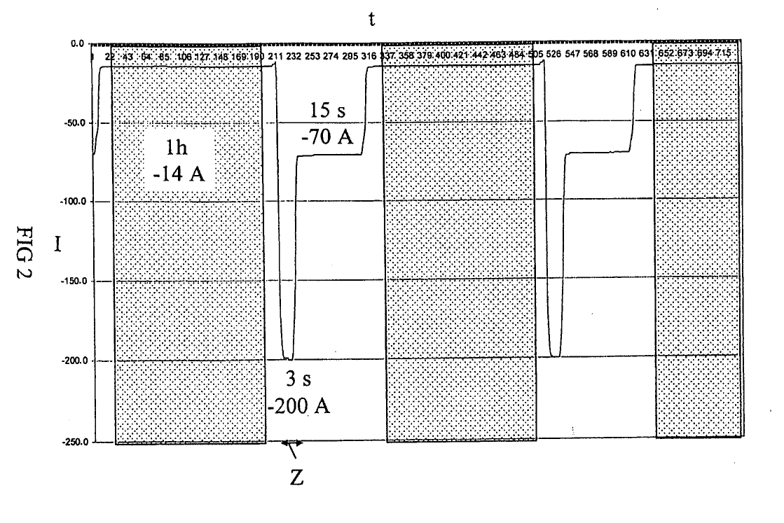

FIGS. 2a, 2b show a diagram with a voltage characteristic and a current characteristic, respectively, for an operating mode which can be predetermined.

Mutually corresponding parts are provided with the same reference symbols in all the figures.

FIG. 1 shows an arrangement 1 with a battery 2 for providing a vehicle power supply system voltage U for a vehicle power supply system 4, in particular in a vehicle 6. The vehicle power supply system 4 is supplied via the connection 8 with the vehicle power supply system voltage U from the battery 2. A monitoring unit 10 is arranged between the battery 2 and the vehicle power supply system 4. The monitoring unit 10 has a sensor 12 for recording the vehicle power supply system voltage U, and a sensor 14 for recording the vehicle power supply system current I. The sensor 12 is a conventional voltage sensor, and the sensor 14 is a conventional current sensor.

Furthermore, the monitoring unit 10 has a computer unit 16 for automatic recording, monitoring and assessment of the vehicle power supply system variables, in particular the vehicle power supply system voltage U and the vehicle power supply system current I. A microcontroller or some other data processing unit is used, for example, as the computer unit 16. The computer unit 16 is in this case connected via a data bus D, for example a CAN bus, to other controllers or systems in the vehicle 6. In particular, the computer unit 16 receives data via the data bus D about any change in the vehicle power supply system load, and this is taken into account when determining the performance of the battery 2. The monitoring unit 10 is also connected to a starter 18, in order to identify a process of starting the vehicle 6.

When the arrangement 1 has been operated, a voltage/current characteristic for an operating mode which can be predetermined is determined by means of the sensors 12 and 14 and is analysed using the computer unit 16. This is done by recording and analysing the vehicle power supply system voltage U and the vehicle power supply system current I within a predetermined time window Z. The computer unit 16 has a timer 20 in order to determine the time window Z.

The voltage/current characteristic is preferably recorded for the “starting process” operating mode, since a higher load and thus a higher vehicle power supply system current I flows during the process of starting the vehicle 6 than is required during a normal operating phase, in particular during an emergency operating phase.

By way of example, FIG. 2 shows a characteristic which describes a test signal for the vehicle power supply system current I. In this case, the battery 2 is loaded with a vehicle power supply system current I of −200 A as being representative of a starting process, in a time window Z lasting for about 3 s. A starting process normally lasts for 0.5 to 1 s, and the battery 2 can be loaded with a vehicle power supply system current I of −700 A to −100 A within three seconds. The test load configured as shown in FIG. 2 with a vehicle power supply system current I of about −200 A for three seconds is an approximation for a laboratory experiment which adequately simulates the starting process. The battery 2 is loaded by means of a further test load with a vehicle power supply system current I of about −70 A for a time period of about 15 seconds. This test load of −70 A for 15 seconds in this case represents the current drawn by critical systems in a vehicle.

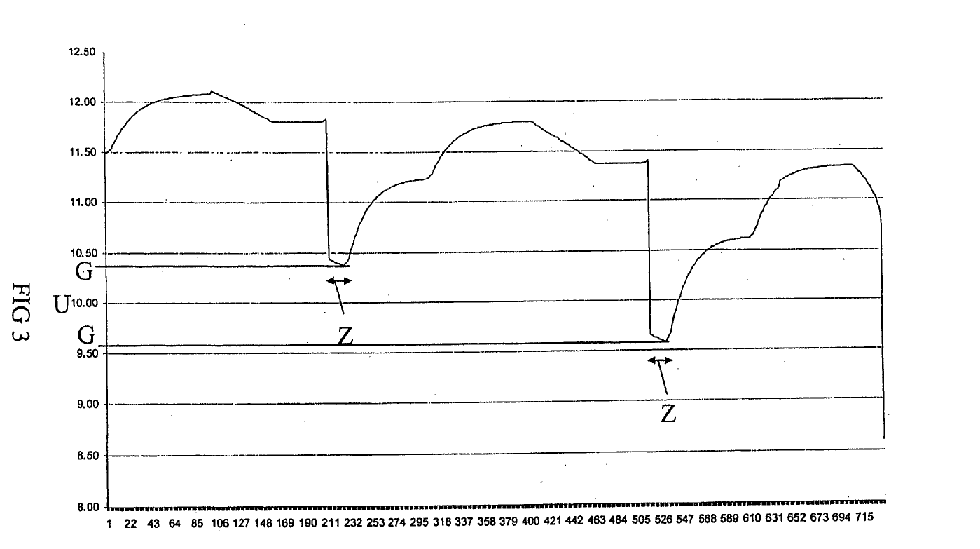

A load on the battery 2 that results from the large amount of current drawn during the starting process is sufficiently high to allow assessment of the future performance of the battery 2 on the basis of this, as a function of the associated characteristic profile of the vehicle power supply system voltage U. In particular, recording the profile of the vehicle power supply system voltage U during the starting process ensures that it is possible on the basis of the large amount of current drawn particularly during the starting process to assess the behavior of the battery 2 when a current of 70 A is drawn for a time period of about 15 seconds, which corresponds approximately to the current drawn by critical systems. The current/voltage characteristic is therefore preferably recorded and analysed during the starting process. For this purpose, FIG. 3 shows the associated characteristic of the vehicle power supply system voltage U during the starting process, particularly in the time window Z. During normal operation, that is to say with a battery 2 as the best possible performance, the vehicle power supply system voltage U rises again, as is illustrated in FIG. 3, at the end of the starting process, in particular at the end of the time window Z. In this case, the computer unit 16 is used to check whether the vehicle power supply system voltage U exceeds a predetermined limit value G at the end of the time window Z, as a function of the vehicle power supply system current I which is emitted.

In other words: in order to allow assessment of the performance of the battery 2, in particular the performance required from the battery 2 for an emergency operating phase of the vehicle 6, a check is carried out for a predetermined load situation, for example the “starting process” operating mode, to determine whether the battery 2 emits a predetermined current at a specific voltage level. For this purpose, the monitoring unit 10 monitors the characteristics, as recorded by means of the sensors 12 and 14, of the vehicle power supply system voltage U and of the vehicle power supply system current I, respectively, for compliance with limit values G which characterize the predetermined load situation. If, as is shown for the starting process in the example in FIG. 3, the vehicle power supply system voltage U rises again at the end of the time window Z and exceeds the lower voltage level, in particular the lower limit value G, then the preconditions for the emergency operating phase are satisfied by the battery 2.

If, on the other hand, the vehicle power supply system voltage U falls below the limit value G or does not rise to an appropriate extent above it in the time period or window Z under consideration, then the battery 2 is no longer suitable for emergency operation. A method such as this which identifies the performance of the battery 2 and is independent of the environmental conditions of the battery 2, independent of rest voltage measurements and thus of rest times, is independent of the battery type and is independent of the rated capacity of the battery 2 ensures that the performance of the battery 2 is monitored continuously, during operation and thus during different operating phases. In this case, these characteristic voltage/current characteristics for the various operating phases or operating modes are stored, and are used by the computer unit 16 for monitoring for compliance with the limit values G on the basis of the instantaneously recorded values of the vehicle power supply system voltage U and vehicle power supply system current I.

Furthermore, a conventional sensor 22 for determining an ambient temperature, particularly in the vicinity of the battery 2, or the engine temperature can additionally be provided.

This makes it possible to take into account the temperature-dependent effects on the battery 2 in the assessment of the battery performance. In order in addition to take account of further conditions, the sensor 14 for recording the vehicle power supply system current I is designed such that the vehicle power supply system current I which flows out of the battery and/or a charging current I_{L} which flows into the battery are/is determined. The currents which are recorded by means of such a bi-directional measuring sensor 14 are used by the computer unit 16 to form a balance. For this purpose, the computer unit 16 has a means 24 for determining the charge balance L on the basis of the vehicle power supply system current I recorded over a time period, and the recorded charging current I_{L}. If this charge balance is positive during this time period, then emergency operation of the battery 2 is allowed. If, on the other hand, the charge balance L of the battery 2 is negative over a lengthy time period, in particular for longer than a predetermined time limit value, that is to say the battery 2 can no longer absorb charge, for example, then emergency operation is no longer adequately ensured. The computer unit 16 emits an appropriate fault signal to the driver of the vehicle 6. A charge balance L which is only briefly or temporarily negative and which does not exceed the time limit value can be output to the driver of the vehicle 6 by means of an appropriate signal.

Furthermore, the available charge in the battery 2 can be taken into account when determining the performance of the battery 2. For this purpose, the data which is transmitted via the data bus D to the computer unit 16 is evaluated and analysed appropriately with regard to changes in the vehicle power supply system load, inter alia, taking into account the battery type and its rated capacity. The time limit value for the negative charge balance L can be set appropriately as a function of the available charge in the battery 2. Furthermore, the available charge or remaining charge in the battery 2 is used together with the battery terminal voltage as a measure of the load capacity of the battery 2.

Depending on the nature and configuration of the monitoring unit 10, further criteria or characteristic variables can be taken into account for determining the performance of the battery 2. The basis for assessing the performance is the detected characteristic of the vehicle power supply system voltage U and vehicle power supply system current I for a predetermined operating mode, in particular for a predetermined time window Z during the operating mode. This provides a particularly simple and reliable method and an appropriately simple and low-cost arrangement 1.

1. A method for determining the performance of a battery (2) for providing a vehicle power supply system voltage (U) for a vehicle power supply system (4), in particular in a vehicle (6), in which method the vehicle power supply system voltage (U) is recorded, characterized in that the vehicle power supply system voltage (U) and the vehicle power supply system current (I) are monitored for an operating mode which can be predetermined within a time window (Z) which can be predetermined, such that the vehicle power supply system voltage (U) at the end of the time window (Z) exceeds a limit value (G) which can be predetermined, as a function of the vehicle power supply system current (I) which is emitted during that operating mode.

2. The method as claimed in claim 1,
characterized in that a check is carried out within the time window (Z) to determine whether the vehicle power supply system voltage (U) falls and rises again in response to the vehicle power supply system current (I) which is characteristic of the relevant operating mode.

3. The method as claimed in claim 1 or 2,
characterized in that a check is carried out during the operating mode to determine whether the vehicle power supply system voltage (U) increases within a time window (Z) which lasts for a few seconds, in particular for 3 or 15 seconds.

4. The method as claimed in one of the preceding claims,
characterized in that a charging current (IL) which flows into the battery (2) and/or a vehicle power supply system current (I) which flows out of the battery (2), is detected during an operating mode which can be predetermined, on the basis of which a charge balance (L) is determined.

5. The method as claimed in claim 4,
characterized in that the charge balance (L) is monitored for a first limit value (G) which can be predetermined having a negative value.

6. The method as claimed in one of the preceding claims,
characterized in that the available charge in the battery (2) is determined.

7. The method as claimed in one of the preceding claims,
characterized in that the vehicle power supply system load is detected.

8. The method as claimed in one of the preceding claims, characterized in that the ambient temperature and/or the engine temperature are recorded.

9. The method as claimed in one of the preceding claims,
characterized in that a process of starting the vehicle (6) is predetermined as the operating mode.

10. An arrangement (1) for determining the performance of a battery (2) for providing a vehicle supply system voltage (U) for a vehicle power supply system (4), in particular in a vehicle (6), characterized in that a monitoring unit (10) is provided, which is arranged between the battery (2) and the vehicle power supply system (4), and has at least one sensor (12) for recording the vehicle power supply system voltage (U) and one sensor (14) for recording the vehicle power supply system current (I), with the monitoring unit (10) having a means (16) for monitoring the vehicle power supply system voltage (U) and the vehicle power supply system current (I) within a time window (Z) which can be predetermined for an operating mode which can be predetermined.

11. The arrangement as claimed in claim 10, characterized in that the sensor (14) is designed to record the vehicle power supply system current (I) such that the vehicle power supply system current (I) which flows out of the battery (2) and/or a charging current (IL) which flows into the battery (2) can be determined.

12. The arrangement as claimed in claim 10 or 11, characterized in that a means (24) is provided for determining a charge balance (L) for the battery (2).

13. The arrangement as claimed in one of the preceding claims,
characterized in that a sensor (22) is provided for determining an ambient temperature or an engine temperature.

14. The arrangement as claimed in one of the preceding claims,
characterized in that a timer (20) is provided for recording the time window (Z).

15. The arrangement as claimed in one of the preceding claims,
characterized in that the monitoring unit (10) has a computer unit (16), in particular a microcontroller, for automatic recording and monitoring of the vehicle power supply system variables.

16. The arrangement as claimed in one of the preceding claims,
characterized in that the monitoring unit (10) is connected to a data bus (D), in particular a CAN bus in the vehicle (6), with a change in the vehicle power supply system load being identified by means of data which is transmitted via the data bus (D).
